(19) United States
(12) Patent Application Publication
(10) Pub. No.: US 2022/0166265 A1
(43) Pub. Date: May 26, 2022

(54) ROTARY MOTOR AND ROBOT

(71) Applicant: Seiko Epson Corporation, Tokyo (JP)

(72) Inventors: Shigekazu TAKAGI, Shiojiri (JP); Hideaki NISHIDA, Suwa (JP); Hiroshi KOEDA, Suwa (JP)

(21) Appl. No.: 17/456,221

(22) Filed: Nov. 23, 2021

(30) Foreign Application Priority Data
Nov. 26, 2020 (JP) 2020-195828

(51) Int. Cl. H02K 1/14; B25J 9/12; H02K 3/52

(52) U.S. Cl. CPC H02K 1/148; H02K 15/02; H02K 3/522; B25J 9/126

(57) ABSTRACT

A rotary motor includes a stator and a rotor configured to rotate around a rotation axis and disposed to be opposed to the stator via a gap. The stator includes a divided core including a base and a teeth section coupled to the base and a coil wound around the teeth section, a signal of one phase among n phases (n is an integer equal to or larger than 3) being supplied to the coil. The stator includes a plurality of the divided cores annularly arranged side by side around the rotation axis. At least one of the plurality of divided cores includes a plurality of the teeth sections as many as a number other than a multiple of n.

The present application is based on, and claims priority from JP Application Serial Number 2020-195828, filed Nov. 26, 2020, the disclosure of which is hereby incorporated by reference herein in its entirety.

### BACKGROUND

### 1. Technical Field

The present disclosure relates to a rotary motor and a robot.

### 2. Related Art

JP-A-2016-32400 (Patent Literature 1) discloses an axial gap motor including a rotation axis that outputs rotation power, a rotor that rotates the rotation axis, and two stators provided across the rotor. Each of the stators includes a plurality of stator dividing sections.

Each of the stator dividing sections includes a coil and a stator core that holds the coil. The stator core includes three stator salient pole sections on which coils of a U phase, a V phase, and a W phase are wound. In the axial gap motor disclosed in Patent Literature 1, a sextet of such stator dividing sections are annularly arranged side by side to configure each of the stators.

By using the stator dividing sections in this way, for example, even when a motor having a large output is manufactured, the same stator dividing sections can be used in common. By dividing the stator core, it is easy to manufacture the stator core and assemble the stator core.

All of the plurality of stator dividing sections described in Patent Literature 1 are formed in the same shape including the three stator salient pole sections on which the coils of the U phase, the V phase, and the W phase are wound. Therefore, when the stator dividing sections are annularly arranged side by side, the stator salient pole section on which the coil of the U phase is wound and the stator salient pole section on which the coil of the W phase is wound are always adjacent to each other via a gap. When the stator salient pole sections of the specific phases are adjacent to each other via the gap in this way, an output of the rotor decreases when magnets included in the rotor pass the gap. As a result, torque fluctuation of the axial gap motor increases.

### SUMMARY

A rotary motor according to an application example of the present disclosure includes: a stator; and a rotor configured to rotate around a rotation axis and disposed to be opposed to the stator via a gap. The stator includes: a divided core including a base and a teeth section coupled to the base; and a coil wound around the teeth section, a signal of one phase among n phases (n is an integer equal to or larger than 3) being supplied to the coil. The stator includes a plurality of the divided cores annularly arranged side by side around the rotation axis. At least one of the plurality of divided cores includes a plurality of the teeth sections as many as a number other than a multiple of n.

A robot according to an application example of the present disclosure includes the rotary motor according to the application example of the present disclosure.

### BRIEF DESCRIPTION OF THE DRAWINGS

FIG. 1 is a longitudinal sectional view showing a schematic configuration of an axial gap motor, which is a rotary motor according to a first embodiment.

FIG. 2 is a perspective view showing only a rotor shown in FIG. 1.

FIG. 3 is a perspective view showing only a stator core included in a stator shown in FIG. 1.

FIG. 4 is a plan view of the stator core shown in FIG. 3 viewed in an axial direction.

FIG. 5 is a plan view showing one of three divided cores included in the stator core shown in FIG. 4.

FIG. 6 is an X-X line sectional view of FIG. 5.

FIG. 7 is a diagram schematically showing a magnetic path at the time when a state in which a coil is wound around the divided coil shown in FIG. 6 and assembled together with the stator and the rotor is simulated.

FIG. 8 is a diagram schematically showing a magnetic path formed on the inside of a divided core when a dividing section is set in a back yoke section included in the stator core before division.

FIG. 9 is a table simulating division patterns of a stator core about a stator including twelve slots annularly arranged side by side.

FIG. 10 is a diagram showing an example of a division pattern of a stator core about a stator including fifty-four slots annularly arranged side by side.

FIG. 11 is a diagram showing an example of a division pattern of the stator core about the stator including the fifty-four slots annularly arranged side by side.

FIG. 12 is a sectional view showing a schematic configuration of a radial gap motor, which is a rotary motor according to a second embodiment.

FIG. 13 is a perspective view showing a robot according to a third embodiment.

FIG. 14 is a schematic diagram of the robot shown in FIG. 13.

### DESCRIPTION OF EXEMPLARY EMBODIMENTS

A rotary motor and a robot according to the present disclosure are explained in detail below with reference to embodiments shown in the accompanying drawings.

### 1. First Embodiment

First, a rotary motor according to a first embodiment is explained.

### 1.1. Structure of the Rotary Motor

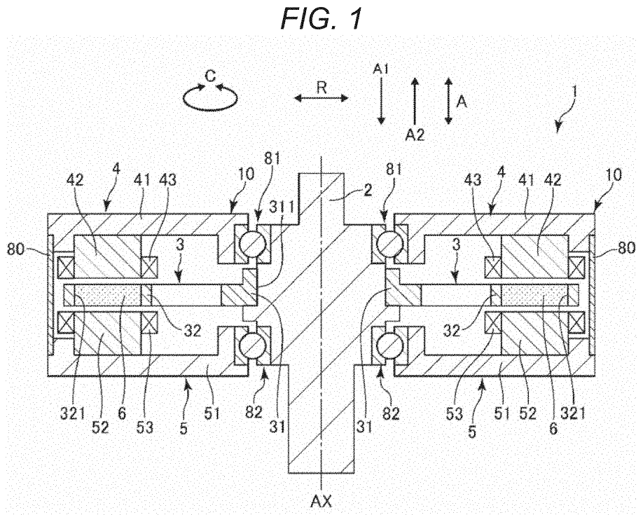

FIG. 1 is a longitudinal sectional view showing a schematic configuration of an axial gap motor, which is the rotary motor according to the first embodiment.

An axial gap motor 1 shown in FIG. 1 is a motor adopting a double stator structure. Specifically, the axial gap motor 1 shown in FIG. 1 includes a shaft 2 configured to rotate around a rotation axis AX, a rotor 3 fixed to the shaft 2 and configured to rotate around the rotation axis AX together with the shaft 2, and a pair of stators 4 and 5 disposed on both sides of the rotor 3 along the rotation axis AX. Such an axial gap motor 1 rotates the rotor 3 and the shaft 2 centering on the rotation axis AX and transmits a rotating force to a driving target member coupled to the shaft 2. The axial gap motor 1 may be a motor adopting a single stator structure.

In the figures of this application, both directions along the rotation axis AX are referred to as “axial direction A”, both directions along the circumference of the rotor 3 are referred to as “circumferential direction C”, and both directions along the radius of the rotor 3 are referred to as “radial direction R”. In the axial direction A, a direction from the stator 4 to the stator 5 is represented as “axial direction A1” and a direction from the stator 5 to the stator 4 is represented as “axial direction A2”.

The shaft 2 has a substantially columnar shape, the outer diameter of which is partially different, and is solid. Consequently, mechanical strength of the shaft 2 is increased. However, the shaft 2 may be hollow.

The rotor 3 having a disk shape is fixed to the shaft 2 concentrically with the shaft 2. The rotor 3 includes a frame 30 and a plurality of permanent magnets 6 disposed in the frame 30.

The stators 4 and 5 are attached to the shaft 2 via bearings 81 and 82. The shaft 2 and the rotor 3 are supported by the bearings 81 and 82 to be rotatable with respect to a motor case 10 configured by combining the stators 4 and 5 using a side surface case 80. In this embodiment, a radial ball bearing is used as the bearings 81 and 82. However, the bearings 81 and 82 are not limited to the radial ball bearing. For example, various bearings such as an axial ball bearing, an angular ball bearing, and a taper roller bearing can be used.

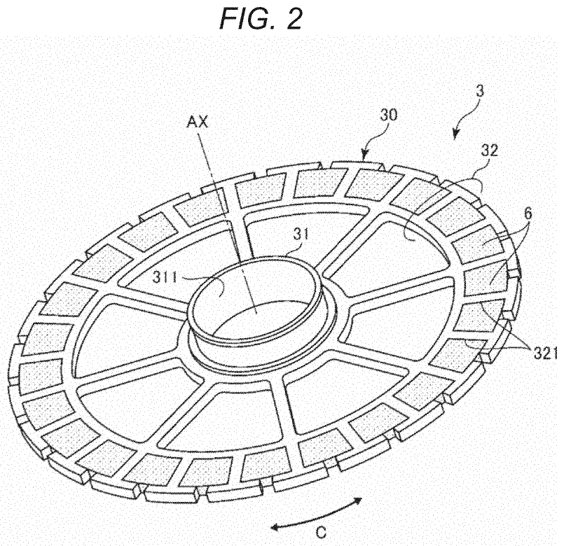

FIG. 2 is a perspective view showing only the rotor shown in FIG. 1.

The rotor 3 shown in FIG. 2 includes the frame 30 including a hub 31 located in the center and an annular rim 32 located further on the outer side than the hub 31.

As shown in FIG. 2, the frame 30 is formed in an annular shape having the center on the rotation axis AX. The frame 30 shown in FIG. 2 includes a through-hole 311 piercing through the frame 30 along the rotation axis AX and a plurality of through-holes 321 provided near the outer edge of the frame 30 and piercing through the frame 30 in the axial direction A. The shaft 2 shown in FIG. 1 is fixed to the through-hole 311 by, for example, press-in. The thickness of the hub 31 along the rotation axis AX, that is, the thickness in the axial direction A of the hub 31 is larger than the thickness of the rim 32. Consequently, the mechanical strength of the hub 31 is high. A method of fixing the shaft 2 and the rotor 3 is not particularly limited. The shape and the like of the hub 31 are not limited to the shape and the like described above.

Examples of a constituent material of the frame 30 include metal materials such as stainless steel, an aluminum alloy, a magnesium alloy, and a titanium alloy, ceramics materials such as alumina and zirconia, resin materials such as engineering plastic, various fiber reinforced plastics such as CFRP (Carbon Fiber Reinforced Plastics) and GFRP (Glass Fiber Reinforced Plastics), and fiber reinforced composite materials such as FRC (Fiber Reinforced Ceramics) and FRM (Fiber Reinforced Metallics).

The constituent material of the frame 30 is preferably a nonmagnetic material. Consequently, the frame 30 is less easily affected by a magnetic flux. A problem such as a decrease in torque less easily occurs. The nonmagnetic material means a material having specific permeability approximately equal to or higher than 0.9 and equal to or lower than 3.0.

The permanent magnets 6 are respectively inserted into the through-holes 321. The number of the permanent magnets 6 is determined by the number of phases and the number of poles of the axial gap motor 1. In this embodiment, as an example, the number of the permanent magnets 6 is twenty-four. Examples of the permanent magnets 6 include a neodymium magnet, a ferrite magnet, a samarium cobalt magnet, an alnico magnet, and a bond magnet. However, the permanent magnets 6 are not limited to these magnets.

The permanent magnets 6 are fixed to the frame 30 using, for example, an adhesive, a fastener, or a binder. The adhesive and other means may be concurrently used. Further, the permanent magnets 6 may be bonded to each other by the adhesive. The adhesive or mold resin may be disposed to cover the permanent magnets 6.

As shown in FIG. 1, the stators 4 and 5 are disposed to sandwich the rotor 3 from both sides in the axial direction A. Specifically, the stator 4 is disposed on the upper side of the rotor 3 via a gap and the stator 5 is disposed on the lower side of the rotor 3 via a gap.

The stator 4 includes an annular case 41 disposed concentrically with the shaft 2, annular stator cores 42 supported on the surface in the axial direction A1 of the case 41 and disposed to be opposed to the permanent magnets 6, and a plurality of coils 43 wound around the stator cores 42.

The stator 5 includes an annular case 51 disposed concentrically with the shaft 2, annular stator cores 52 supported on the surface in the axial direction A2 of the case 51 and disposed to be opposed to the permanent magnets 6, and a plurality of coils 53 wound around the stator cores 52.

The stator cores 42 and 52 are made of any one of various magnetic materials such as a laminated body of electromagnetic steel plates, a pressurized powder body of magnetic powder, and a hybrid body obtained by combining the electromagnetic steel plates and the magnetic powder, in particular, a soft magnetic material.

The configurations of the stators 4 and 5 are further explained below. However, since the stators 4 and 5 have the same configuration, the stator 5 is representatively explained below. Explanation about the stator 4 is omitted.

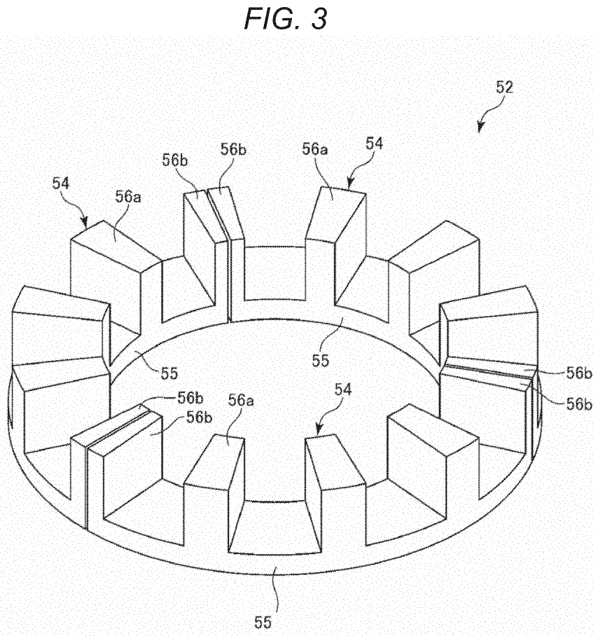

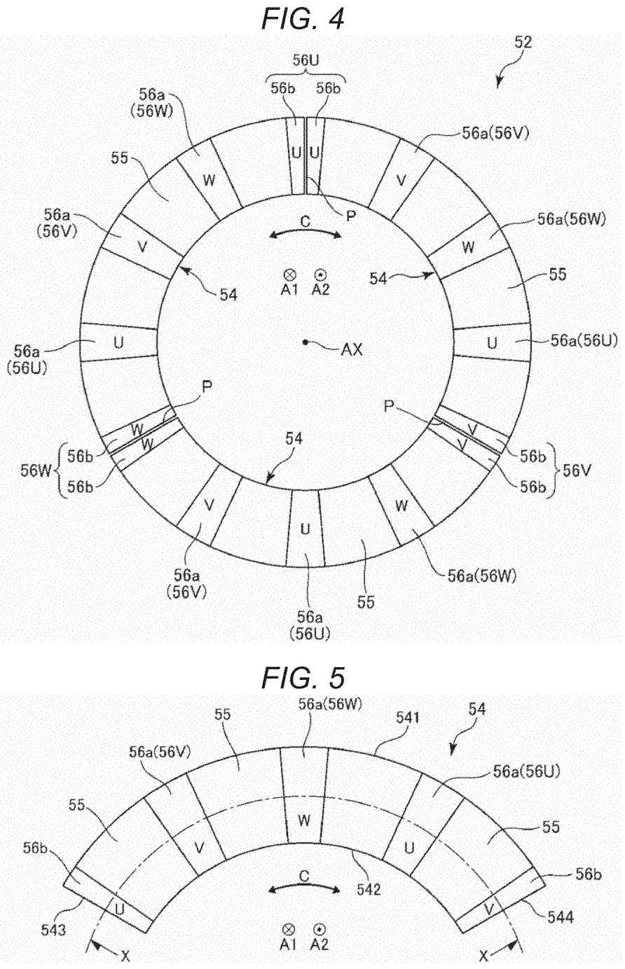

FIG. 3 is a perspective view showing only the stator core 52 included in the stator 5 shown in FIG. 1. FIG. 4 is a plan view of the stator core 52 shown in FIG. 3 viewed in the axial direction A1.

The stator core 52 shown in FIGS. 3 and 4 is a core used in the stator 5 including twelve slots annularly arranged side by side and is configured by an aggregate of three divided cores 54. The divided cores 54 are formed in the same shape. The three divided cores 54 are disposed to have an annular shape as a whole, whereby the stator core 52 is configured. Therefore, the divided core 54 is equivalent to one member at the time when a stator core formed in an annular shape is assumed and the stator core is divided into three. The stator core formed in the annular shape is hereinafter referred to as “stator core before division”.

By using the aggregate of the divided cores 54 as the stator core 52, it is possible to improve manufacturing easiness of the stator core 52 compared with when the stator core before division is used. That is, since the stator core before division is large, for example, when the stator core before division is molded by pressurized powder molding, a large mold is necessary. Therefore, manufacturing difficulty is high and manufacturing cost increases.

In contrast, since the divided cores 54 are small compared with the stator core before division, a mold can also be small. Consequently, it is possible to improve the manufacturing easiness and reduce the manufacturing cost.

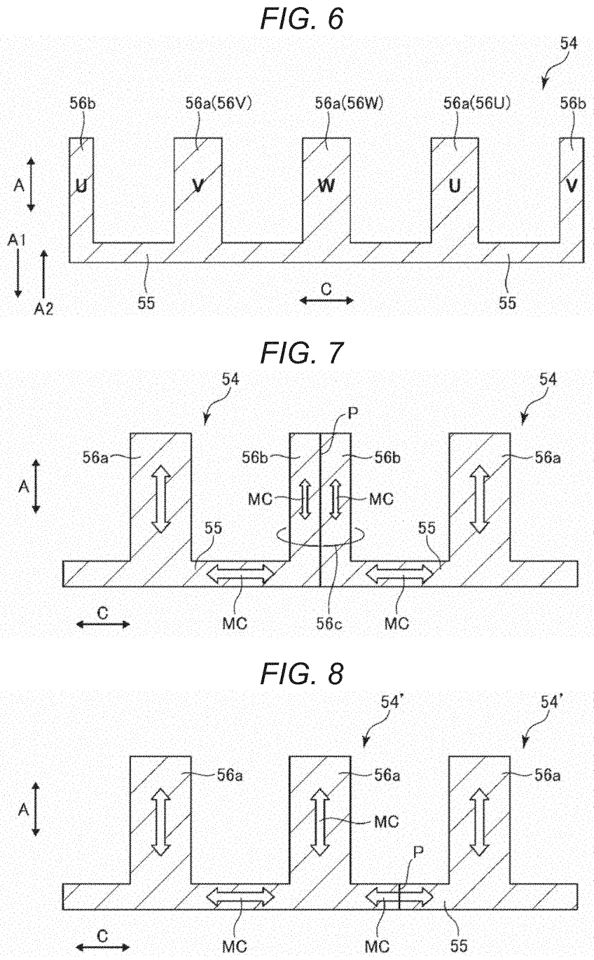

FIG. 5 is a plan view showing one of the three divided cores 54 included in the stator core 52 shown in FIG. 4. FIG. 6 is an X-X line sectional view of FIG. 5.

The divided core 54 shown in FIGS. 5 and 6 is equivalent to a member obtained by equally dividing the stator core 52 formed in the annular shape into three in the circumferential direction C. Therefore, a plan view shape of the divided core 54 is an “annular divided shape” surrounded by two arcs 541 and 542 having the center in common and having different radiuses and two line segments 543 and 544 extending in the radial direction of the arcs 541 and 542. Both of the center angles of the two arcs 541 and 542 are 120°.

The divided core 54 shown in FIGS. 5 and 6 includes a back yoke section 55 (a base) formed in the annular divided shape explained above in a plan view and teeth sections 56a and 56b projecting in the axial direction A2 from the back yoke section 55. The back yoke section 55 is a plate-like body formed in the annular divided shape. The teeth sections 56a and 56b are respectively columnar bodies, the bottom surfaces of which are formed in trapezoidal shapes. The width in the circumferential direction C of the teeth sections 56a is set relatively large. The width in the circumferential direction C of the teeth sections 56b is set to a half of the width in the circumferential direction C of the teeth sections 56a.

When the stator core before division is divided, positions of the division are not particularly limited. However, in FIGS. 3 and 4, the position is set to a teeth section included in the stator core before division. Therefore, the teeth sections 56b included in the divided core are equivalent to parts obtained by dividing the teeth sections included in the stator core before division into halves.

On the other hand, the teeth sections 56a included in the divided core 54 are teeth sections obtained by directly shifting the teeth sections included in the stator core before division to the divided cores 54. Therefore, when the three divided cores 54 are annularly disposed as shown in FIGS. 3 and 4, the teeth sections 56b are adjacent to each other in a boundary between two divided cores 54 adjacent to each other. As a result, from a viewpoint of a magnetic circuit, a part equivalent to one teeth section 56a is formed by two teeth sections 56b adjacent to each other.

Therefore, an effect of improving the manufacturing easiness and reducing the manufacturing cost is obtained by using the divided cores 54 and, on the other hand, an adverse effect on the magnetic circuit involved in the division is reduced.

FIG. 7 is a diagram schematically showing a magnetic path MC formed on the insides of the divided cores 54 when dividing sections P are set in the teeth sections included in the stator core before division as shown in FIGS. 3 and 4, that is, when the divided cores 54 shown in FIG. 6 are set adjacent to each other in the dividing section P. In other words, FIG. 7 is a diagram schematically showing the magnetic path MC at the time when a state in which the coil 53 is wound around the divided cores 54 shown in FIG. 6 and assembled together with the stator 4 and the rotor 3 is simulated.

As shown in FIG. 7, the magnetic path MC formed on the insides of the divided cores 54 extends substantially parallel to the longitudinal directions of parts. Therefore, even if the teeth section before division is divided in the dividing section P parallel to the axial direction A, the division less easily affects the magnetic path MC. Therefore, when the dividing section P is set as the teeth section before division, an adverse effect on the magnetic circuit involved in the division can be minimized.

As explained above, in this embodiment, since the dividing sections P are set in the teeth sections of the stator core before division, when the teeth section 56b included in one of the divided cores 54 adjacent to each other is represented as a first teeth section and the teeth section 56b included in the other is represented as a second teeth section, as shown in FIG. 7, the teeth section 56a and the teeth section 56b configure an aggregate 56c of the first teeth section and the second teeth section. The coil 53 shown in FIG. 1 is wound around the aggregate 56c shown in FIG. 7.

With such a configuration, as explained above, the dividing sections P less easily adversely affect a magnetic path formed on the inside of the stator core 52. Therefore, even if the stator core 52 is configured by the divided corers 54, it is possible to suppress the torque of the axial gap motor 1 from decreasing accordingly.

In contrast, FIG. 8 is a diagram schematically showing the magnetic path MC formed on the insides of divided cores 54′ when the dividing section P is set in the back yoke section 55 included in the stator core before division.

As shown in FIG. 8, the magnetic path MC formed on the insides of the divided cores 54′ crosses the dividing section P. Therefore, the magnetic path MC is adversely affected by the dividing section P and magnetic resistance increases. Then, compared with FIG. 7, an increase in the torque of the axial gap motor 1 is slightly inferior. However, in terms of the fact that a phase of a coil attached to teeth sections close to the dividing section P does not deviate to a specific phase, even in the position of the dividing section P shown in FIG. 8, an effect of reducing torque fluctuation of the axial gap motor 1 is obtained.

In the following explanation, when the number of the teeth sections 56a and 56b included in the divided core 54 is counted, the teeth section 56a is counted as one and the teeth section 56b is counted as a half. Therefore, the aggregate 56c is counted as one. When the stator core before division is divided, a dividing position of a teeth section is preferably a position where the teeth section is divided into two but may be a position other than the position.

The stator core 52 may be fixed to the case 51 by, for example, melting, an adhesive, or welding or may be engaged with the case 51 using various engagement structures.

As shown in FIG. 1, the coil 53 is wound around the teeth sections 56a and 56b of the stator core 52. An electromagnet is configured by the stator core 52 and the coil 53. The coil 53 may be a lead wire wound around the teeth sections 56a and 56b of the stator core 52. A lead wire may be wound on a bobbin or the like in advance and fit in the teeth sections 56a and 56b.

The axial gap motor 1 includes a not-shown energization circuit. The coils 53 are coupled to the energization circuit. To the coils 53, n-phase (n is an integer equal to or larger than 3) signals having different phases of a multiphase alternating current are supplied. In this specification, as an example, an energization circuit for a three-phase alternating current that supplies three signals of the U phase, the V phase, and the W phase respectively to the coil 53 for the U phase, the coil 53 for the V phase, and the coil 53 for the W phase is explained. Examples of the multiphase alternating current include a four-phase alternating current and a five-phase alternating current besides the three-phase alternating current.

When the three-phase alternating current is applied to the coils 53, an attraction force or a repulsion force is generated between electromagnets and the permanent magnets 6 opposed to the electromagnets. The generation of such forces is periodically repeated, whereby a driving force for rotating the rotor 3 around the rotation axis AX is generated.

In such an axial gap motor 1, the teeth sections 56a and 56b of the stator core 52 are also divided into teeth sections for the U phase, the V phase, and the W phase. In FIGS. 4 to 6, any one of U, V, and W is displayed in the teeth sections 56a and 56b. The teeth sections 56a and 56b in which U is displayed are particularly represented as “U-phase teeth section 56U”. The teeth sections 56a and 56b in which V is displayed are particularly represented as “V-phase teeth section 56V”. Further, the teeth sections 56a and 56b in which W is displayed are particularly represented as “W-phase teeth section 56W”. The display of U, V, and W is repeated along the circumferential direction C.

In the stator core 52, the three divided cores 54 are arranged side by side via the dividing sections P. Each of the divided cores 54 includes four teeth sections 56a and 56b. Therefore, the stator core 52 includes twelve teeth sections 56a and 56b in total. In other words, the number of slots of the stator 5 is twelve.

In this way, in this embodiment, the number of the teeth sections 56a and 56b included in the divided core 54 is set to a number other than a multiple of 3, which is the number of phases of the three-phase alternating current. When this is expanded to an n-phase alternating current, the number of teeth sections included in a divided core only has to be set to a number other than a multiple of n.

By setting the number of the teeth sections 56a and 56b included in the divided core 54 to such a number, when the divided cores 54 are annularly disposed side by side, it is possible to prevent three dividing sections P from deviating to a teeth section of a specific phase. In the case of FIG. 4, the three dividing sections P can be allocated to the U-phase teeth section 56U, the V-phase teeth section 56V, and the W-phase teeth section 56W one by one. By allocating the teeth sections where the dividing sections P are provided to the three phases, it is possible to suppress mutual action of the stator 5 and the rotor 3 from deviating to a specific phase of the three-phase alternating current.

Specifically, when the dividing sections P are opposed to the permanent magnets 6 of the rotor 3, an output of the axial gap motor 1 is likely to decrease. However, in FIG. 4, the dividing sections P that cause such an output decrease are equally distributed to the three phases. Consequently, it is possible to reduce the width of the output decrease compared with when the dividing sections P are set in a teeth section of a specific phase.

As explained above, the axial gap motor 1 (the rotary motor according to the first embodiment) includes the stators 4 and 5 and the rotor 3 that rotates around the rotation axis AX and is disposed to be opposed to the stators 4 and 5 via gaps. The stator 5 includes the divided core 54 including the back yoke section 55 (the base) and the teeth sections 56a and 56b coupled to the back yoke section 55 and the coil 53 wound around the teeth sections 56a and 56b, a signal of one phase among n phases (n is an integer equal to or larger than 3) being supplied to the coil 53. The stator 5 includes the plurality of divided cores 54 annularly arranged side by side around the rotation axis AX. At least one of the plurality of divided cores 54 includes the teeth sections 56a and 56b as many as a number other than a multiple of n.

With such a configuration, as explained above, it is possible to prevent the dividing sections P, which are gaps between the divided cores 54, from deviating to the teeth section 56b of a specific phase. When the three-phase alternating current is used as in this embodiment, the dividing sections P can be allocated to the teeth sections 56b of at least two phases, preferably, the teeth sections 56b of three phases.

If the number of teeth sections included in divided cores is three, which is a multiple of n, the number of divided cores is four. Gaps between the divided cores deviate to a teeth section of any one of the U phase, the V phase, and the W phase. In contrast, in this embodiment, since the number of the teeth sections 56a and 56b included in the divided core 54 is set to four, which is not a multiple of n, the positions of the dividing sections P can be shifted. Consequently, it is possible to prevent the dividing sections P from deviating to the teeth section 56b of a specific phase. As a result, it is possible to reduce the width of an output decrease due to the dividing sections P and reduce torque fluctuation of the axial gap motor 1. Therefore, it is possible to achieve improvement of efficiency of the axial gap motor 1.

Such an advantageous effect with respect to the related art is also obtained when the dividing section P is set in the back yoke section 55 as explained above. However, from a viewpoint of further reducing the torque fluctuation, the dividing section P is preferably set in the teeth section 56b.

All of the three divided cores 54 preferably include the teeth sections 56a and 56b as many as a number other than a multiple of n. Specifically, since the axial gap motor 1 according to this embodiment is driven by a three-phase alternating current, all of the numbers of the teeth sections 56a and 56b included in the four divided cores 54 are set to four, which is a number other than a multiple of 3 such as 3, 6, and 9.

With such a configuration, the action explained above, that is, the action of allocating the dividing sections P to the teeth sections 56b of different phases in any positions in the entire stator core 52 is obtained. Further, more advantageous action of allocating two dividing sections P including both ends of one divided core 54 to the teeth sections 56b of phases different from each other is obtained.

This action is explained more in detail. If the divided core 54 including teeth sections as many as a multiple of 3 is present among the three divided cores 54, a dividing section including both ends of the divided core 54 is excited by signals of the same phase. In contrast, if there is no divided core including teeth sections as many as a multiple of 3, two dividing sections P including both ends of one divided core 54 are always excited by signals of phases different from each other.

By setting the positions of the dividing sections P based on such a principle, even if the dividing sections P are allocated to the same phase in any position in the entire stator core 52, it is possible to separate physical positions of the dividing sections P from one another. As a result, it is possible to prevent a situation in which torque fluctuation of the axial gap motor 1 occurs at a specific mechanical angle and controllability is deteriorated.

The configuration of the stator core is not limited to this and may include a divided core including teeth section as many as a number of a multiple of n. That is, the stator core may be configured by a divided core including teeth sections as many as a number other than a multiple of n and a divided core including teeth sections as many as a number of a multiple of n.

The stator 5 preferably includes the divided cores 54 as many as a multiple of n. Specifically, since the axial gap motor 1 according to this embodiment is driven by the three-phase alternating current, the number of the divided cores 54 included in one stator 5 is three, which is a multiple of 3.

With such a configuration, by adjusting a method of allocating the dividing sections P, as shown in FIG. 4, three dividing sections P can be equally allocated to three places of the U-phase teeth section 56U, the V-phase teeth section 56V, and the W-phase teeth section 56W. As a result, it is possible to further reduce torque fluctuation involved in deviation of the positions of the dividing sections P to a teeth section of a specific phase.

The configuration of the stator is not limited to this. The number of divided cores included in the stator may be a number other than a multiple of n.

A total number of the teeth sections 56a and 56b included in the stator 5 is preferably a multiple of n. Specifically, since the axial gap motor 1 according to this embodiment is driven by the three-phase alternating current, the number of the teeth sections 56a and 56b included in one stator 5 is twelve, which is a multiple of 3.

With such a configuration, the U phase, the V phase, and the W phase of the three-phase alternating current can be equally allocated to the twelve teeth sections 56a and 56b. That is, the number of U-phase teeth sections 56U, the number of V-phase teeth sections 56V, and the number of W-phase teeth sections 56W can be set equal to one another. Therefore, it is possible to realize the axial gap motor 1 excellent in controllability.

### 1.2. Example of a Division Pattern (Twelve Slots

The stator core 52 shown in FIGS. 3 and 4 is configured by the three divided cores 54 as explained above. The divided cores 54 have the same shape.

On the other hand, a division pattern of the stator core 52 is not limited to such a pattern. Various patterns are conceivable.

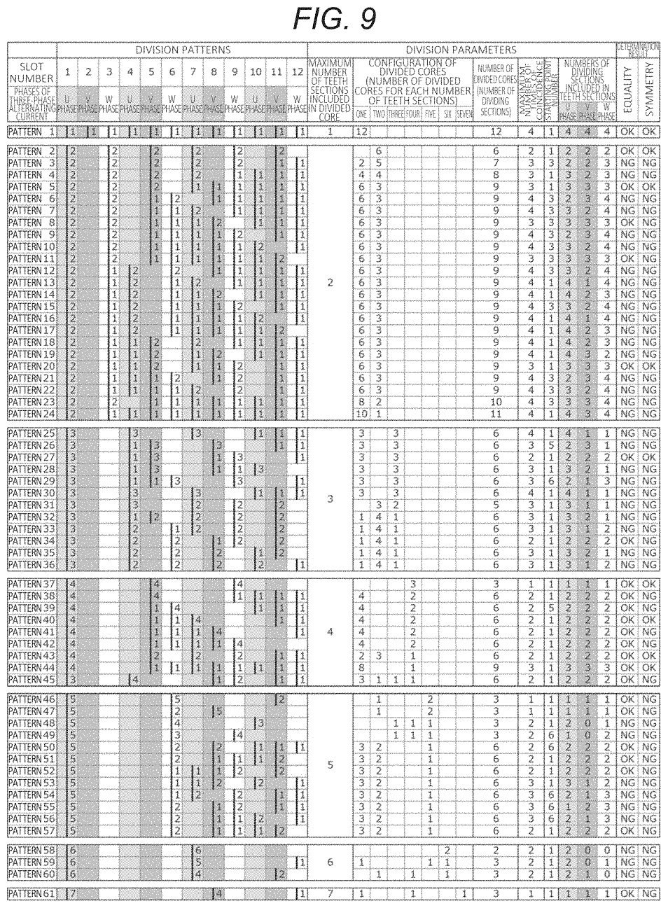

FIG. 9 is a table simulating division patterns of a stator core about a stator including twelve slots annularly arranged side by side.

In a first row of a column describing the division patterns shown in FIG. 9, slot numbers of the twelve slots are shown. The slot numbers are numbers sequentially allocated to teeth sections when a divided core having the largest number of included teeth sections among divided cores annularly arranged side by side is set as a starting point.

In a second row of the column describing the division patterns, phases of a three-phase alternating current corresponding to the slot numbers are described.

In third and subsequent rows of the column describing the division patterns, division patterns simulating positions of dividing sections of the stator core corresponding to the twelve slots are listed in order from a pattern 1. When a vertical solid line is drawn in the center of a column to which a slot number is allocated, this indicates that a dividing section is set in a teeth section of the slot number. Therefore, a range sandwiched by vertical solid lines is equivalent to a divided core.

In the column describing the division patterns shown in FIG. 9, the number of teeth sections included in one divided core is shown. Specifically, the column describing the division patterns in FIG. 9, a number is described between the vertical solid lines representing the dividing sections. The number represents the number of teeth sections included in each single divided core.

In a column describing division parameters in FIG. 9, division parameters corresponding to the division patterns are shown. The division parameters are six items described below.

A maximum number of teeth sections included in a divided core

A configuration of the divided core (the number of divided cores for each number of teeth sections)

The number of divided cores (the number of dividing sections)

A maximum number of times of coincidence

A slot number (a starting point number) serving as a starting point at the maximum number of times of coincidence

The numbers of dividing sections included in teeth sections of the U phase, the V phase, and the W phase

As shown in FIG. 9, a stator core may include two or more types of divided cores in which the numbers of teeth sections are different from one another. The maximum number of teeth sections included in the divided core, which is one of the six items, is the number of teeth sections included in a divided core in which the number of teeth sections is the largest when the stator core includes two or more types of divided cores.

The configuration of the divided core is the numbers of divided core included in the stator core totalized for each of the numbers of teeth sections included in the divided cores.

The maximum number of times of coincidence and the starting point number are explained in detail below.

The numbers of dividing sections included in teeth sections of the U phase, the V phase, and the W phase are a result obtained by totalizing in which of the teeth sections of the U phase, the V phase, and the W phase the dividing sections are located.

In a column describing a determination result in FIG. 9, determination results about two determination items are shown in order to determine whether the division patterns are useful in controllability of the axial gap motor. The determination items are two items described below.

Uniformity The numbers of dividing sections included in the teeth sections of the U phase, the V phase, and the W phase are equal to one another

Symmetry Having a “repetition structure” structurally repeated at a cycle including two or more teeth sections adjacent to one another

In FIG. 9, OK is displayed when the items are satisfied and NG is displayed when the items are not satisfied.

When the division patterns have uniformity, as explained above, the dividing sections are equally distributed to three-phase teeth sections. Therefore, it is possible to reduce the width of an output decrease compared with when the dividing sections are distributed to only a teeth section of a specific phase.

When the division patterns have symmetry, mechanical and electrical symmetries of the axial gap motor are increased. Therefore, when the axial gap motor is driven, the stator core is less easily deformed and an output decrease due to uneven distribution of the dividing sections is suppressed. As a result, it is possible to realize the axial gap motor with vibration and torque fluctuation suppressed.

The determination result shown in FIG. 9 indicates whether higher effects of the uniformity and the symmetry are obtained. Therefore, even in a pattern not having both of the uniformity and the symmetry, a basic effect of not deviating the dividing sections to a teeth section of one phase is obtained. However, a pattern 58 is an exception because all of the numbers of teeth sections included in the divided cores are multiples of 3.

### 1.2.1. Uniformity

When the simulation explained above is examined, all of the division patterns shown in FIG. 9 include one or more divided cores, the numbers of teeth sections included therein being numbers other than a multiple of 3. Moreover, in order to satisfy at least the uniformity of the two determination items, the following two elements (a) and (b) need to be satisfied.

(a) The number of divided cores is a multiple of 3
(b) When, about divided cores annularly arranged side by side, the numbers of teeth sections are accumulated with the divided cores set as starting points, a maximum value of the number of times a cumulative number of the teeth sections coincides with a multiple of 3 is the number of times equal to or smaller than one third of the number of divided cores

The element (a) is as explained above.

The element (b) is that, about divided cores annularly arranged side by side, the numbers of teeth sections are accumulated with the divided cores set as starting points, and a maximum value of the number of times a cumulative number of the teeth sections coincides with a multiple of 3 satisfies a reference range of one third or less of the number of divided cores.

Specifically, the numbers of teeth sections are accumulated toward one side of the circumferential direction C with one of the divided cores annularly arranged side by side set as a starting point. When the numbers of all the teeth sections are accumulated, the number of times a cumulative number of the teeth sections coincide with a multiple of 3 (the number of times of coincidence) is counted. Such calculation of the number of times of coincidence is performed at all starting points to calculate a maximum value of the numbers of times of coincidence. The maximum value of the numbers of times of coincidence is represented as a “maximum number of times of coincidence”. A slot number set as a starting point when the maximum number of times of coincidence is obtained is represented as a “starting point number”. If the maximum number of times of coincidence is within the reference range of one third or less of the number of divided cores, the element (b) is satisfied. If the maximum number of times of coincidence is more than one third, the element (b) is not satisfied. The element (b) is further explained below with reference to patterns 52 and 53 as an example.

In the pattern 52, as shown in FIG. 9, since the starting point number at which the maximum number of times of coincidence is obtained is 1, the accumulation is started from a slot number 1. The number of teeth sections from a dividing section with the slot number 1 to a dividing section with a slot number 6 is five. When the number of teeth sections from the dividing section with the slot number 6 to a dividing section with a slot number 7 is added to the number, a cumulative number is six. Since the cumulative number is a multiple of 3, the number of times of coincidence is one at this point in time. Subsequently, when the number of teeth sections from the dividing section with the slot number 7 to a dividing section with a slot number 8 is added, a cumulative number is seven. Subsequently, when the number of teeth sections from the dividing section with the slot number 8 to a dividing section with a slot number 9 is added, a cumulative number is eight. Subsequently, when the number of teeth sections from the dividing section with the slot number 9 to a dividing section with a slot number 11 is added, a cumulative number is ten. Subsequently, when the number of teeth sections from the dividing section with the slot number 11 to the dividing section with the slot number 1 is added, a cumulative number is twelve. Since the cumulative number is a multiple of 3, the number of times of coincidence is two at this point in time.

When the number of times the cumulative number of the teeth sections coincides with a multiple of 3 is counted as explained above, a total number of times is two in the pattern 52. The number of times is the maximum number of times of coincidence of the pattern 52. In the pattern 52, the maximum number of times of coincidence is within a reference range of one third or less of 6, which is the number of divided cores of the pattern 52, that is, 2 or less. Accordingly, the pattern 52 satisfies the element (b).

On the other hand, in the pattern 53, as shown in FIG. 9, since the starting point number at which the maximum number of times of coincidence is obtained is 1, the accumulation is started from the slot number 1. The number of teeth sections from the dividing section with the slot number 1 to the dividing section with the slot number 6 is five. When the number of teeth sections from the dividing section with the slot number 6 to the dividing section with the slot number 7 is added to the number, a cumulative number is six. Since the cumulative number is a multiple of 3, the number of times of coincidence is one at this point in time. Subsequently, when the number of teeth sections from the dividing section with the slot number 7 to the dividing section with the slot number 8 is added, a cumulative number is seven. Subsequently, when the number of teeth sections from the dividing section with the slot number 8 to a dividing section with a slot number 10 is added, a cumulative number is nine. Since the cumulative number is a multiple of 3, the number of times of coincidence is two at this point in time. Subsequently, when the number of teeth sections from the dividing section with the slot number 10 to a dividing section with a slot number 12 is added, a cumulative number is 11. Subsequently, when the number of teeth sections from the dividing section with the slot number 12 to the dividing section with the slot number 1 is added, a cumulative number is 12. Since the cumulative number is a multiple of 3, the number of times of coincidence is three at this point in time.

When the number of times the cumulative number of the teeth sections coincide with a multiple of 3 is counted as explained above, a total number of times is three in the pattern 53. The number of times is the maximum number of times of coincidence of the pattern 53. In the pattern 53, the maximum number of times of coincidence deviates from the reference range of one third or less of 6, which is the number of divided cores of the pattern 53, that is, 2 or less. Accordingly, the pattern 53 does not satisfy the element (b).

When the division parameters are compared between the pattern 52 and the pattern 53, it is seen that, in the pattern 52 that satisfies the element (b), each of the numbers of dividing sections included in the teeth sections of the U phase, the V phase, and the W phase is two. Therefore, the pattern 52 satisfies the uniformity.

On the other hand, in the pattern 53 that does not satisfy the element (b), for example, the number of dividing sections included in the U-phase teeth section is three. Then, since the number of divided cores is six, it is impossible to equally allocate the dividing sections to teeth sections of the U phase, the V phase, and the W phase. Therefore, the pattern 53 does not satisfy the uniformity.

Accordingly, satisfying both of the element (a) and the element (b) can be considered a precondition for equally allocating the dividing sections to the teeth sections of the U phase, the V phase, and the W phase.

As explained above, when the numbers of the teeth sections are accumulated with one divided core among the plurality of divided cores annually arranged side by side set as the starting point and the number of times the cumulative number of the teeth sections coincides with a multiple of n is totalized for each of the divided cores to calculate the maximum value (the maximum number of times of coincidence), the maximum number of times of coincidence is preferably the number of times equal to or smaller than 1/n of the number of divided cores included in the stator. Specifically, in the example shown in FIG. 9, since the three-phase alternating current is used, the maximum value of the number of times the cumulative number of the teeth sections coincides with a multiple of 3 (the maximum number of times of coincidence) is preferably the number of times equal to or smaller than one third of the number of divided cores.

By satisfying such elements, it is possible to equally allocate the dividing sections to the teeth sections of the phases and improve the uniformity of the stator core. The example explained above is the case of the twelve slots. However, the above explanation does not depend on the number of slots.

### 1.2.2. Symmetry

In order to satisfy the symmetry of the two determination items, two elements (c) and (d) described below need to be satisfied.

(c) The maximum number of teeth sections included in the divided core is smaller than a half of the number of slots (a total number of teeth section in the stator)
(d) The number of divided cores, in which the numbers of teeth sections are the same, is an even number or a multiple of 3

The element (c) is that, for example, when the number of slots is twelve, the maximum number of teeth sections included in the divided core is set to a number smaller than six. When the maximum number is six or more, it is difficult to realize the “repetition structure” indicated by the definition of the symmetry explained above. It is difficult to secure the symmetry.

In this way, in the stator, the maximum number of teeth sections included in the divided core is preferably smaller than a half of the total number of teeth sections. That is, in all the divided cores, the numbers of teeth sections included in the divided cores are preferably set to a number smaller than a half of the total number of teeth sections included in the stator. Consequently, since structural deviation of the stator core is suppressed, it is easy to realize the “repetition structure” and improve the symmetry.

On the other hand, the element (d) is that, in the configuration of the divided core, which is one of the division parameters, the number of divided cores totalized for each of the numbers of teeth sections is an even number or a multiple of 3. When the stator core satisfies the element (d), structural symmetry is further improved.

What is considered from the entire FIG. 9 is that, by using a plurality of types of divided cores, it is easy to secure the uniformity and the symmetry while suppressing the number of divided cores. That is, a plurality of divided cores preferably include two types of cores, that is, a first core and a second core, the number of teeth sections included therein being different from the number of teeth sections of the first core. For example, in the case of a pattern 27 shown in FIG. 9, three divided cores (first cores) in which the number of teeth sections is three and three divided cores (second cores) in which the number of teeth sections is one are used. This secures both of the uniformity and the symmetry while reducing the number and the types of the divided cores.

When the number of divided cores is increased, the size of one divided core can be reduced. Therefore, manufacturing easiness of the divided cores is improved. On the other hand, since the number of divided cores is large, assembly manhour increases. When the types of the divided cores are increased, manufacturing cost increases. Therefore, the number and the types of the divided cores only have to be optimized considering a balance of the manufacturing easiness, the manufacturing cost, and the assembly manhour.

### 1.3. Example of a Division Pattern (Fifty-Four Slots

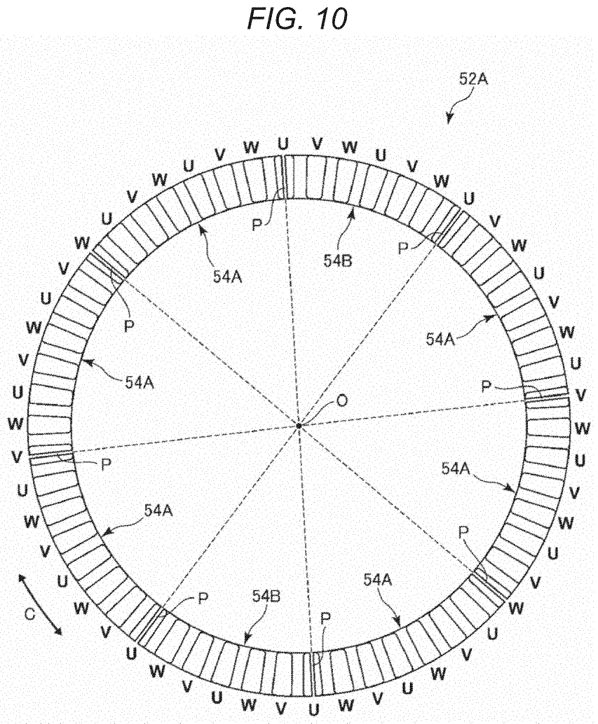

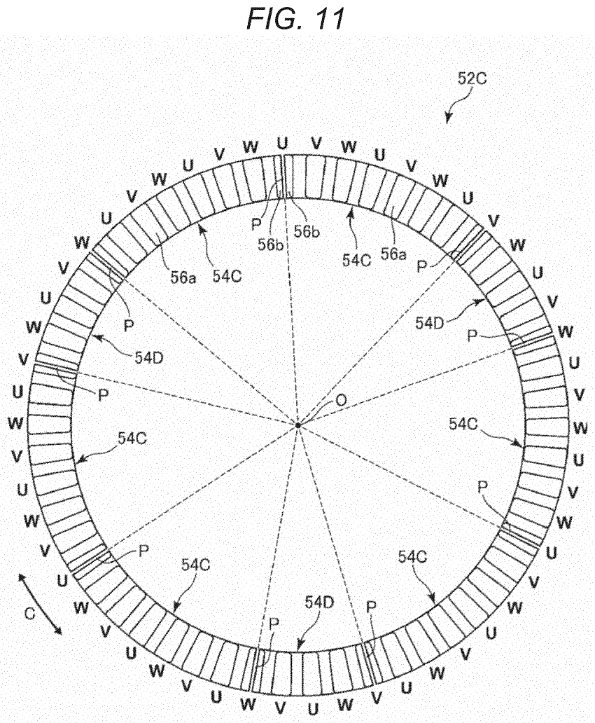

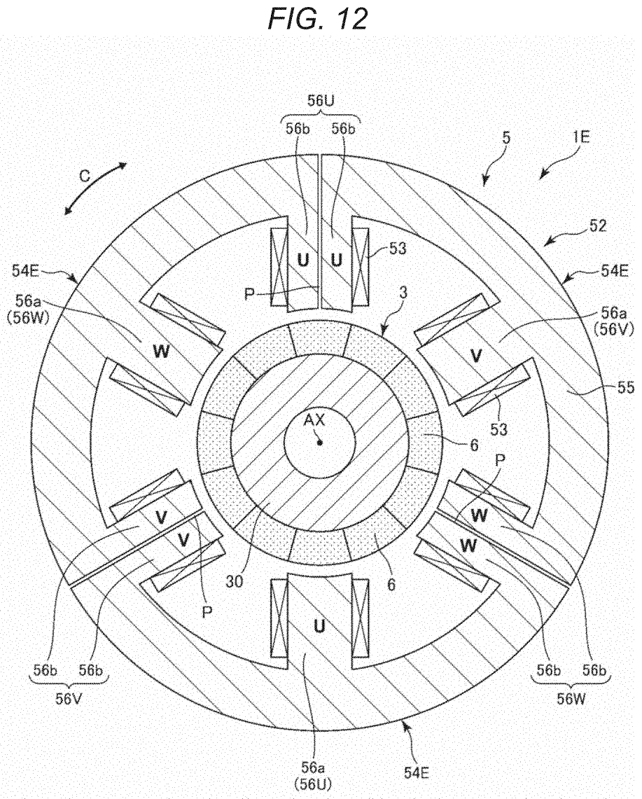

FIGS. 10 and 11 are respectively diagrams showing examples of division patterns of a stator core about a stator including fifty-four slots annularly arranged side by side.

A stator core 52A shown in FIG. 10 is configured by six divided cores 54A and two divided cores 54B.

The number of the teeth sections 56a and 56b included in the divided core 54A is seven and the number of teeth sections 56a and 56b included in the divided core 54B is six.

In the stator core 52A, one repetition structure is formed by three divided cores 54A and one divided core 54B. The stator core 52A includes a pair of the repetition structures. Consequently, the symmetry is secured.

On the other hand, the stator core 52A includes eight dividing sections P in total. Among the eight dividing sections P, four dividing sections P are allocated to the U-phase teeth section 56U. Two dividing sections P are allocated to each of the V-phase teeth section 56V and the W-phase teeth section 56W. Therefore, in the stator core 52A, although the eight dividing sections P are allocated to three phases, the numbers of the dividing sections P allocated to the sections are different from one another. Therefore, the uniformity is not secured.

A stator core 52C shown in FIG. 11 is configured by six divided cores 54C and three divided cores 54D.

The number of the teeth sections 56a and 56b included in the divided core 54C is seven and the number of the teeth sections 56a and 56b included in the divided core 54D is four.

In the stator core 52C, one repetition structure is formed by two divided cores 54C and one divided core 54D. The stator core 52C includes a trio of the repetition structures. Consequently, the symmetry is secured. Since the number of repetition structures is the odd number, when a center O of the stator core 52C is set as the center of symmetry, it is possible to prevent the positions of the dividing sections P from becoming point symmetry (180° rotation symmetry). Consequently, it is possible to further increase the mechanical strength of the stator core 52C.

On the other hand, the stator core 52C includes nine dividing sections P in total. The dividing sections P are equally allocated to the U-phase teeth section 56U, the V-phase teeth section 56V, and the W-phase teeth section 56W. Consequently, the uniformity is also secured.

### 2. Second Embodiment

A rotary motor according to a second embodiment is explained.

FIG. 12 is a sectional view showing a schematic configuration of a radial gap motor, which is the rotary motor according to the second embodiment.

The second embodiment is explained below. However, in the following explanation, differences from the first embodiment are mainly explained. Explanation about similarities to the first embodiment is omitted. In FIG. 12, the same components as the components in the first embodiment are denoted by the same reference numerals and signs.

The rotary motor according to this embodiment is the same as the rotary motor according to the first embodiment explained above except that, whereas the rotary motor according to the first embodiment is the axial gap motor 1, the rotary motor according to this embodiment is a radial gap motor 1E.

The radial gap motor 1E shown in FIG. 12 includes the stator 5 located on the outer circumference side and the rotor 3 located on the inner circumference side and disposed to be opposed to the stator 5 via a gap.

The rotor 3 includes the frame 30 capable of rotating around the rotation axis AX and the plurality of permanent magnets 6 arranged side by side in the circumferential direction C around the rotation axis AX.

The stator 5 includes the annular stator core 52 and the plurality of coils 53 wound around the stator cores 52.

The stator core 52 shown in FIG. 12 is a core including six slots annularly arranged side by side and is configured by an aggregate of three divided cores 54E. The divided cores 54E are formed in the same shape. Each of the divided cores 54E includes the teeth sections 56a and 56b as many as a number other than a multiple of 3, specifically, two teeth sections 56a and 56b.

With such a configuration, it is possible to prevent the dividing sections P, which are the gaps between the divided cores 54E, from deviating to the teeth section 56b of a specific phase. When the three-phase alternating current is used as in this embodiment, the dividing sections P can be allocated to three teeth sections, that is, the U-phase teeth section 56U, the V-phase teeth section 56V, and the W-phase teeth sections 56W. As a result, it is possible to reduce the width of an output decrease due to the dividing sections P and reduce torque fluctuation of the radial gap motor 1E.

In the second embodiment explained above, the same effects as the effects in the first embodiment are obtained.

### 3. Third Embodiment

A robot according to a third embodiment is explained.

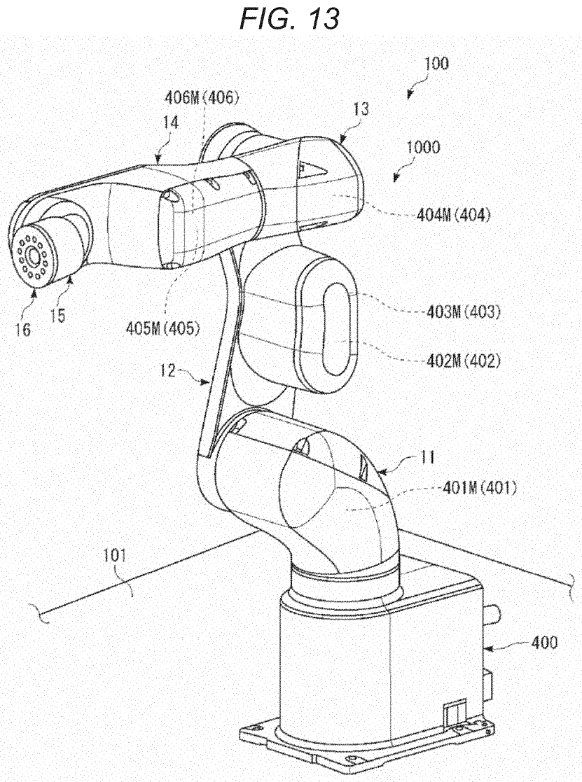

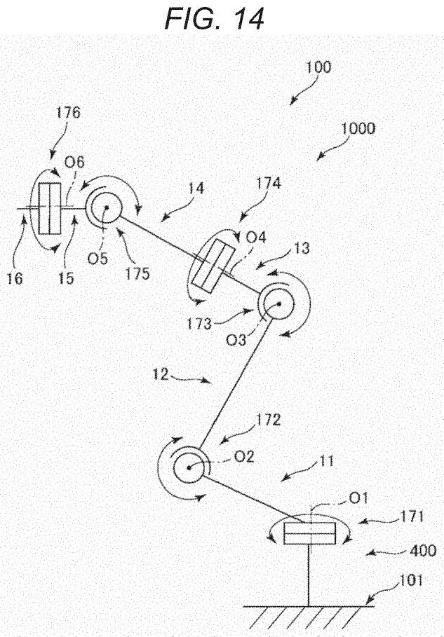

FIG. 13 is a perspective view showing the robot according to the third embodiment. FIG. 14 is a schematic diagram of the robot shown in FIG. 13.

A robot 100 shown in FIG. 13 is used in kinds of work such as conveyance, assembly, and inspection of various workpieces (target objects).

As shown in FIGS. 13 and 14, the robot 100 includes a base 400, a robot arm 1000, and driving sections 401 to 406.

The base 400 shown in FIGS. 13 and 14 is placed on a flat floor 101. The base 400 may be placed not on the floor 101 but on a wall, a ceiling, a stand, or the like.

The robot arm 1000 shown in FIGS. 13 and 14 includes a first arm 11, a second arm 12, a third arm 13, a fourth arm 14, a fifth arm 15, and a sixth arm 16. A not-shown end effector can be detachably attached to the distal end of the sixth arm 16. A workpiece can be, for example, gripped by the end effector. The workpiece, for example, gripped by the end effector is not particularly limited. Examples of the end effector include an electronic component and an electronic device. In this specification, the base 400 side based on the sixth arm 16 is represented as “proximal end side” and the sixth arm 16 side based on the base 400 is represented as “distal end side”.

The end effector is not particularly limited. Examples of the end effector include a hand that grips the workpiece and a suction head that sucks the workpiece.

The robot 100 is a single-arm six-axis vertical articulated robot in which the base 400, the first arm 11, the second arm 12, the third arm 13, the fourth arm 14, the fifth arm 15, and the sixth arm 16 are coupled in this order from the proximal end side toward the distal end side. In the following explanation, the first arm 11, the second arm 12, the third arm 13, the fourth arm 14, the fifth arm 15, and the sixth arm 16 are respectively referred to as “arms” as well. The lengths of the arms 11 to 16 are respectively not particularly limited and can be set as appropriate. The number of arms included in the robot arm 1000 may be one to five or seven or more. The robot 100 may be a SCARA robot or may be a double-arm robot including two or more robot arms 1000.

The base 400 and the first arm 11 are coupled via a joint 171. The first arm 11 is capable of turning with respect to the base 400 with a first turning axis O1 parallel to the vertical axis as a turning center. The first arm 11 is turned by driving of the driving section 401 including a motor 401M and a not-shown speed reducer. The motor 401M generates a driving force for turning the first arm 11.

The first arm 11 and the second arm 12 are coupled via a joint 172. The second arm 12 is capable of turning with respect to the first arm 11 with a second turning axis O2 parallel to the horizontal plane as a turning center. The second arm 12 is turned by driving of the driving section 402 including a motor 402M and a not-shown speed reducer. The motor 402M generates a driving force for turning the second arm 12.

The second arm 12 and the third arm 13 are coupled via a joint 173. The third arm 13 is capable of turning with respect to the second arm 12 with a third turning axis O3 parallel to the horizontal plane as a turning center. The third arm 13 is turned by driving of the driving section 403 including a motor 403M and a not-shown speed reducer. The motor 403M generates a driving force for turning the third arm 13.

The third arm 13 and the fourth arm 14 are coupled via a joint 174. The fourth arm 14 is capable of turning with respect to the third arm 13 with a fourth turning axis O4 parallel to the center axis of the third arm 13 as a turning center. The fourth arm 14 is turned by driving of the driving section 404 including a motor 404M and a not-shown speed reducer. The motor 404M generates a driving force for turning the fourth arm 14.

The fourth arm 14 and the fifth arm 15 are coupled via a joint 175. The fifth arm 15 is capable of turning with respect to the fourth arm 14 with a fifth turning axis O5 orthogonal to the center axis of the fourth arm 14 as a turning center. The fifth arm 15 is turned by driving of the driving section 405 including a motor 405M and a not-shown speed reducer. The motor 405M generates a driving force for turning the fifth arm 15.

The fifth arm 15 and the sixth arm 16 are coupled via a joint 176. The sixth arm 16 is capable of turning with respect to the fifth arm 15 with a sixth turning axis O6 parallel to the center axis of the distal end portion of the fifth arm 15 as a turning center. The sixth arm 16 is turned by driving of the driving section 406 including a motor 406M and a not-shown speed reducer. The motor 406M generates a driving force for turning the sixth arm 16.

The rotary motor according to any one of the embodiments explained above is used as at least one of the motors 401M to 406M. That is, the robot 100 includes the rotary motor according to any one of the embodiments explained above.

The rotary motor according to any one of the embodiments has less torque fluctuation and high efficiency and controllability. Therefore, the robot 100 is excellent in controllability of the robot arm 1000 and is excellent in convenience of use. When the rotary motor is the axial gap motor, it is possible to easily achieve a reduction in the size and improvement of design flexibility of the robot arm 1000. Further, by using the rotary motor according to any one of the embodiments, it is possible to achieve an increase in the torque of the motors 401M to 406M, remove the speed reducers, and enable direct drive of the driving sections 401 to 406.

Not-shown angle sensors are provided in the driving sections 401 to 406. Examples of the angle sensors include various encoders such as a rotary encoder. The angle sensors detect turning angles of output shafts of the motors or the speed reducers of the driving sections 401 to 406.

The driving sections 401 to 406 and the angle sensors are respectively electrically coupled to not-shown robot control devices. The robot control devices independently control the operations of the driving sections 401 to 406.

The rotary motor and the robot according to the present disclosure are explained above with reference to the embodiments shown in the figures. However, the present disclosure is not limited to the embodiments.

For example, the rotary motor and the robot according to the present disclosure may be respectively a rotary motor and a robot in which the sections in the embodiments are replaced with any components having the same functions or may be a rotary motor and a robot in which any components are added to the embodiments.

What is claimed is:

1. A rotary motor comprising:
a stator; and
a rotor configured to rotate around a rotation axis and disposed to be opposed to the stator via a gap, wherein
the stator includes:
a divided core including a base and a teeth section coupled to the base; and
a coil wound around the teeth section, a signal of one phase among n phases (n is an integer equal to or larger than 3) being supplied to the coil,
the stator includes a plurality of the divided cores annularly arranged side by side around the rotation axis, and
at least one of the plurality of divided cores includes a plurality of the teeth sections as many as a number other than a multiple of n.

2. The rotary motor according to claim 1, wherein all of the plurality of divided cores include the teeth sections as many as a number other than a multiple of n.

3. The rotary motor according to claim 1, wherein the stator includes the divided cores as many as a multiple of n.

4. The rotary motor according to claim 1, wherein the plurality of divided cores include:
a first core; and
a second core different from the first core in a number of the teeth sections included in the second core.

5. The rotary motor according to claim 1, wherein, when numbers of the teeth sections are accumulated with one of the plurality of divided cores annularly arranged side by side set as a starting point and numbers of times a cumulative number of the teeth sections coincide with a multiple of n are totalized for each of the divided cores to calculate a maximum value, the maximum value is a number of times equal to or smaller than 1/n of a number of the divided cores included in the stator.

6. The rotary motor according to claim 1, wherein a total number of the teeth sections included in the stator is a multiple of n.

7. The rotary motor according to claim 1, wherein the number of teeth sections included in the divided core is smaller than a half of a total number of the teeth sections included in the stator.

8. The rotary motor according to claim 1, wherein, when the teeth section included in one of the divided cores adjacent to each other is represented as a first teeth section and the teeth section included in another is represented as a second teeth section, the coil is wound around an aggregate of the first teeth section and the second teeth section.

9. A robot comprising the rotary motor according to claim 1.
